(19) United States
(12) Patent Application Publication
(10) Pub. No.: US 2009/0165056 A1
(43) Pub. Date: Jun. 25, 2009

(54) METHOD AND APPARATUS FOR SCHEDULING A RECORDING OF AN UPCOMING SDV PROGRAM DELIVERABLE OVER A CONTENT DELIVERY SYSTEM

(75) Inventor: Carlton J. Sparrell, Marblehead, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/960,414

(22) Filed: Dec. 19, 2007

(51) Int. Cl. G06F 3/00

(52) U.S. Cl. 725/58

(57) ABSTRACT

A set top terminal includes a tuner for receiving SDV programs over a content delivery system, an SDV module for coordinating SDV sessions in cooperation with an SDV manager associated with the content delivery system, and a DVR module for coordinating storage and playback of SDV programs received over the content delivery system. The SDV module is configured to transmit a message over the content delivery system substantially in advance of a time at which an upcoming SDV program is scheduled to be recorded by the DVR module. The message specifies when the upcoming SDV program has been scheduled for recording. A processor operationally associated with the tuner, the SDV module and the DVR module.

### FIELD OF THE INVENTION

The present invention relates generally to a switched digital video system for distributing content to a subscriber over a system such as a satellite or cable television system, and more particularly to a switched digital video system in which a subscriber can scheduling upcoming SDV programs for recording.

### BACKGROUND OF THE INVENTION

Switched digital video (SDV) refers to an arrangement in which broadcast channels are only switched onto the network when they are requested by one or more subscribers, thereby allowing system operators to save bandwidth over their distribution network. In conventional cable or satellite broadcast systems, every broadcast channel is always available to all authorized subscribers. In contrast, a switched digital video channel is only available when requested by one or more authorized subscribers. Also, unlike video on-demand, which switches a singlecast interactive program to a user, switched digital video switches broadcast streams, making each stream available to one or more subscribers who simply join the broadcast stream just as they would with normal broadcast services. That is, once a switched service is streamed to a subscriber, subsequent subscribers associated with the same service group as the first subscriber can tune to the same broadcast stream. The switched digital video will often share the same resource managers and underlying resources with other on-demand services.

As noted, switched digital video is largely a tool to save bandwidth. From the subscriber perspective, he or she still receives the same broadcast video service when using a switched broadcast technique; ideally the user is not able to discern that the stream was switched at all. If each one of the digital broadcast channels is being watched by subscribers in the same service group, the switched digital video approach does not yield any bandwidth savings. However, a more likely situation statistically is that only a certain number of the digital broadcast channels are being watched by subscribers in the same service group at any given time. Those channels not requested by a subscriber need not be broadcast, thereby saving bandwidth.

One way to support switched digital video is to utilize a session manager to manage SDV sessions and provision services. The subscriber's receiver (e.g., a set top terminal) will request an SDV program from the session manager. The session manager will determine if the requested channel is already being sent to the corresponding service group that the subscriber belongs to. The subscriber receiver will be assigned to join the existing SDV service if the requested channel is available at the service group or assigned to a new SDV service if the requested channel is not available at the service group. The Session Manager will negotiate with the edge devices to allocate resources required for the service. The edge device (e.g., a digital modulator such as a QAM modulator) needs to dynamically retrieve the MPEG single program transport stream that carries the requested broadcast program (likely via IP unicast or multicast) and generate the MPEG multiple program transport stream. As part of the service setup response message, the video tuning parameters such as frequency and MPEG program number are sent back to the subscriber to access the requested broadcast channel.

Subscriber receivers such as set top terminals are increasingly incorporating digital video recorder (DVR) functionality to record programming that is received over the content delivery system. DVRs can be used to record SDV and non-SDV (e.g., broadcast) programming. In many cases the subscriber can conveniently record a desired program using an electronic program guide (EPG), which is an interactive, on-screen display feature that displays information analogous to TV listings found in local newspapers or other print media. An EPG provides information about each program being broadcast within the time period covered by the EPG, which typically ranges from the next hour up to several days. The information contained in an EPG includes programming characteristics such as, for example, channel number, program title, start time, end time, elapsed time, time remaining, and a brief description of the program's content. Using the DVR system, the EPG allows the viewer to automatically record a program based on the information in the EPG.

When a viewer begins watching and/or recording an SDV channel, the bandwidth of the QAM modulator distributing the SDV channel is reduced. That is, each time an SDV channel is bound to a QAM modulator its remaining available bandwidth decreases. Since bandwidth resources are limited, the session manager needs to plan the allocation of bandwidth to the full extent possible. For example, if an SDV channel is not being watched or recorded by a subscriber, the channel should be switched off so that the bandwidth can be reallocated. Accordingly, when a viewer switches from an SDV to a non-SDV (e.g., broadcast) channel, or when the set top terminal or television is turned off, or when the recording of an SDV channel is terminated, the session manager is notified so that it can immediately reassign the network resources. Similarly, when a viewer switches to an SDV channel, the session manager is notified so that the bandwidth can be immediately allocated, if available. Unfortunately, neither situation provides the session manager with any forward-looking information concerning the amount of SDV bandwidth that will be needed a few minutes, hours or even days in advance

### BRIEF DESCRIPTION OF THE DRAWINGS

FIG. 1 shows a content delivery system architecture for delivering switched digital channels to a subscriber during a switched digital video (SDV) session.

FIG. 2 shows one example of a headend.

FIG. 3 shows the logical architecture of one particular example of a set top terminal.

FIG. 4 shows one example of the hardware that may be employed by a set top terminal.

FIG. 5 is flowchart showing one example of a method by which the SDV manager or other suitable entity in the content delivery system delivers SDV programs that are to be recorded by subscriber terminals.

### DETAILED DESCRIPTION

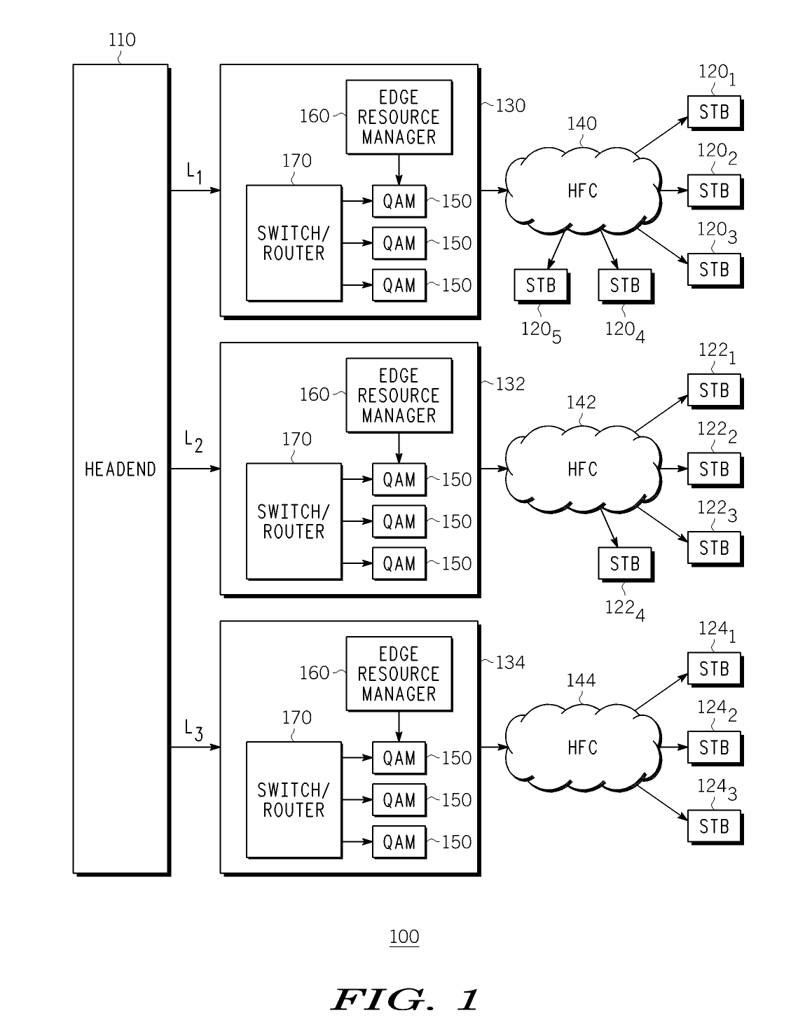

FIG. 1 is a content delivery system architecture 100 for delivering switched digital channels to a subscriber during a switched digital video (SDV) session. The SDV session is implemented through a service offering in which application level data generated by a set top terminal initiates a SDV session request and an SDV manager routes data in accordance with the request to provision the service. Among other components, system architecture 100 comprises a content source such as a headend 110 that is connected to multiple intermediate entities such as hubs 130, 132 and 134. The headend 110 communicates with a switch or router 170 in hubs 130, 132 and 134 over links L1, L2 and L3, respectively. The headend 110 and hubs 130, 132, and 134 may communicate over a packet-switched network such as a cable data network, passive optical network (PON) or the like using, for example, IP multicast addressing.

Some or even all of the hubs are connected to multiple users, typically via distribution networks such as local cable access networks (e.g., HFC networks). For simplicity of explanation only, each hub is shown as being connected to a distinct HFC network, which in turn communicate with end user equipment as illustrated. In particular hubs 130, 132 and 134 in FIG. 1 communicate with access networks 140, 142 and 144, respectively. Each access network 140, 142 and 144 in turn communicates with multiple end user devices such as set top or subscriber terminals. In the example of FIG. 1, access network 140 communicates with set top terminals 120₁, 120₂, 120₃, 120₄ and 120₅, access network 142 communicates with set top terminals 122₁, 122₂, 122₃ and 122₄, and access network 144 communicates with set top terminals 124₁, 124₂ and 124₃.

In addition to the switch or router 170, each hub can include an array of radio frequency transmitter edge devices such as edge QAM modulators 150. The number of edge devices 150 in each hub may vary as needs dictate. As used herein, the term “QAM” refers to modulation schemes used for sending signals over cable access networks. Such modulation schemes might use any constellation level (e.g. QAM-16, QAM-64, QAM-256 etc.) depending on the details of a cable access network. A QAM may also refer to a physical channel modulated according to such schemes. Typically, a single QAM modulator can output a multiplex of ten or twelve programs, although the actual number will be dictated by a number of factors, including the communication standard that is employed. The edge QAM modulators usually are adapted to: (i) receive Ethernet frames that encapsulate the transport packets, (ii) de-capsulate these frames and remove network jitter, and (iii) transmit radio frequency signals representative of the transport stream packets to end users, over the HFC network. Each transport stream is mapped to a downstream QAM channel. Each QAM channel has a carrier frequency that differs from the carrier frequency of the other channels. The transport streams are mapped according to a channel plan designed by the MSO that operates the network.

Each hub 130, 132 and 134 also includes an edge resource manager 160 for allocating and managing the resources of the edge devices 150. The edge resource manager 160 communicates with and receives instructions from the session manager located in the headend 110. In some case the edge resource manager and/or session manager can be located in the headend.

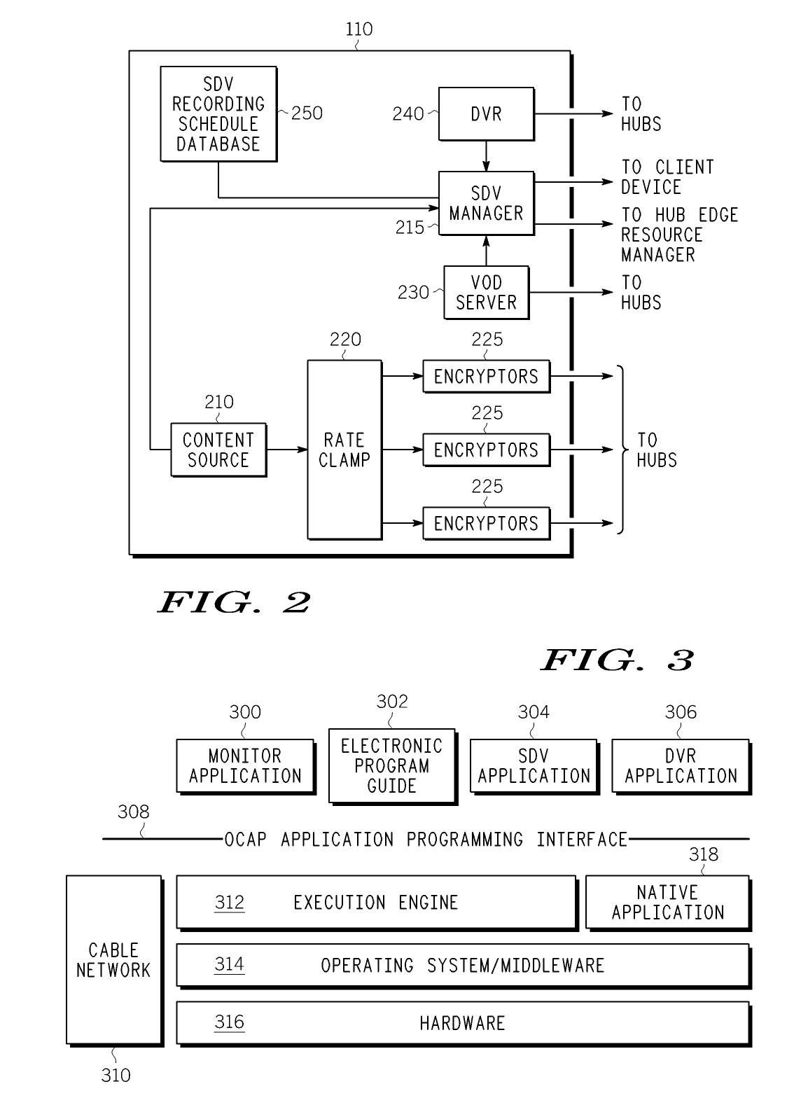

FIG. 2 shows one example of headend 110. The headend 110 includes a broadcast content source 210, which may include, by way of example, satellite receivers, off-air receivers and/or content storage devices such as servers. A SDV manager 215 is used to determine which SDV transport streams are being transmitted at any time and for directing the set top terminals to the appropriate stream. The SDV manager 215 also keeps track of which subscribers are watching which channels and it communicates with the edge resource managers 160 in the hubs so that the content can be switched on and off under the control of the SDV manager 215. In addition, all subscriber requests for a switched digital channel go through the SDV manager 215. The switched digital channels are forwarded to a rate clamp 220 and one or more encryptors 225 using, for example, IP multicast addressing. The content is then encrypted by the encryptors 225 and transmitted to the appropriate hub or hubs. Typically, standard definition (SD) channels are currently rate clamped to 3.75 Mbps while high definition channels are currently rate clamped to between about 12 Mbps and 15 Mbps. The encryptors 225 encrypt the digitally encoded content, often under the control of a conditional access system (not shown).

Headend 110 may also include a network DVR 240. The network DVR 240 stores content that can be transmitted to set top terminal via a hub and access network in response to a user request to play a program stored on the DVR 240. Other user input requests are also serviced by network DVR 240, including, for example, requests to accelerate the playing of a program in the forward direction (e.g., cueing) and in the reverse direction (e.g., reviewing). The content is stored by the network DVR 240 upon a user request. The content may be provided to the network DVR 240 from any available content source, including, for example, content source 210.

It should be noted that in some cases some or all of the functionality of the SDV manager 215 may be transferred to each of the hubs 130, 132 and 134. For example, as described below, SDV programming may be scheduled for recording by the hubs, which may also allocate the necessary bandwidth between the edge devices and the set top terminals.

Headend 110 may also include a variety of other components for offering additional services. For example, in FIG. 2 a video on demand (VOD) server 230 is shown for storing programs or other content for distribution to subscribers on an on-demand basis. Although not shown, one of ordinary skill in the art would recognize that other components and arrangements for achieving the various functionalities of headend 110 are possible. For example, the headend 110 may comprise typical headend components and services including a billing module, an advertising insertion module, a subscriber management system (SMS), a conditional access system and a LAN(s) for placing the various components in data communication with one another. It will also be appreciated that the headend configuration depicted in FIG. 2 is a high-level, conceptual architecture and that each network may have multiple headends deployed using different architectures.

The edge devices 150 provide programming to the set top terminals using the downstream in-band channels. To communicate control information and the like with the headend 110 and/or the relevant hub, the set top terminals may use out-of-band (OOB) or DOCSIS channels or an IP tunnel or an IP connection and associated protocols. However, in some cases communication of control information and the like can be performed using in-band channels as well.

FIG. 3 shows the logical architecture of one particular example of a set top terminal. In this example the set top terminal is compliant with the OpenCable Application Platform (OCAP) hardware and software environment. The OCAP specification is a middleware software layer specification intended to enable the developers of interactive television services and applications to design such products so that they will run successfully on any cable television system, independent of set top or television receiver hardware or operating system software choices. As is well known, middleware generally comprises one or more layers of software which are positioned “between” application programs and the lower or physical layers of the network device. Middleware is commonly written for the specific requirements of the operator of the computer system, and the proprietary software purchased by the operator of the computer system. A key role of middleware is to insulate the application programs from the device specific details. By using middleware the application programmers need know very little about the actual network details, since they can rely on the middleware to address the complexities of interfacing with the network. Of course, the set top terminal is not limited to an OCAP-compliant software/hardware architecture. In other cases, for example, the set top terminals may be compliant with MHEG, DASE or Multimedia Home Platform (MHP) middleware. Alternatively, the set top terminal may be based on a proprietary architecture.

Referring to FIG. 3, the top of an OCAP software “stack” includes a Monitor Application Module 300, Electronic Program Guide (EPG) Module 302, SDV application Module 304 and DVR application Module 306. These applications are run on top of a software layer called the “Execution Engine” 312 and interface to the Execution Engine using the well known OCAP APIs 308. The client device may also include certain software applications or “Native Applications” 318 that do not run within the Execution Engine, but directly run on top of the Operating System/Middleware 314 for the client device. Native Applications are typically written for, e.g., a particular hardware configuration 316 of the set top terminal. Examples of such Native Applications may include management of front panel functionality, remote control interaction, games, and the like. It should be noted that while Monitor Application Module 300, Electronic Program Guide (EPG) Module 302, SDV application Module 304 and DVR application Module 306 are depicted as residing on top of the execution engine 312, in some cases one or more of these applications may be integrated with the execution engine 312 or any other module residing below the OCAP APIs 308. Accordingly, processes that are described herein as being performed by the DVR or EPG applications may alternatively be performed by the execution engine 312 or any other appropriate module or component.

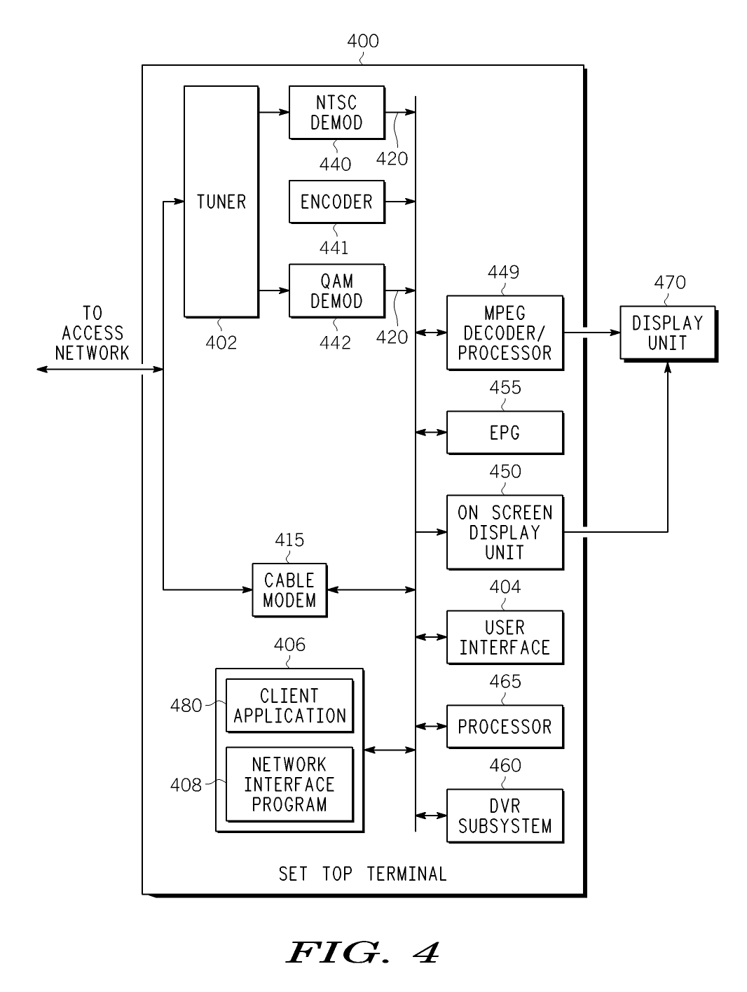

One example of a set top terminal 400 is shown in more detail in FIG. 4 It should be noted that set top terminal 400 more generally may be any apparatus such as a hardware card, specially programmed computer or other device having the functionality described herein that may be placed near to or within a television or other display device (such as a computer monitor) such as display unit 470. The set top terminal 400 receives content from cable access networks seen in FIG. 1. Broadly speaking, a traditional set top terminal such as that depicted in FIG. 4 is a device that can receive, store and forward content without manipulating the content in any significant way except to format it so that it may be rendered in a suitable manner.

Set top terminal 400 includes one or more in-band tuners 402 (only one of which is shown in FIG. 4), which tunes to a program selected by a consumer (not shown) via user interface 404. User interface 404 may be any control device such as a remote control, mouse, microphone, keyboard, or display. NTSC demodulator 440 and digital demodulator 442 are responsive to in-band tuner 402. NTSC demodulator 440 includes components responsive to receive analog versions of a channel signal. A digital demodulator 442, which as shown is a QAM demodulator, but, which may be any type of digital demodulator device, includes components responsive to receive digital versions of a channel signal, and to output video information. QAM demodulator 442 receives and processes digital data packets from one or more digital sources, such as a digital television signal, an MPEG transport stream, or a media stream from an external network connection, such as cable modem 415 (if available), using well-known methods and techniques.

Demodulators 440 and 442 are operative to output video information 420. Video information 420 includes raw video and/or audio data, arranged for formatting in accordance with a predetermined media format. Video information 420 is preferably arranged in accordance with an MPEG media format, such as the MPEG-2 media format, but may be arranged in accordance with other media formats, including but not limited to other MPEG formats, Hypertext Markup Language (HTML), Virtual Hypertext Markup Language (VHTML), X markup language (XML), H.261, or H.263 formats.

Video information that may require format translation or modification for compatibility with capabilities of set top terminal 400 may be passed to encoder 441 for formatting. Video information that is in a format preferred for use by MPEG Decoder/Multi Media Processor 449 may be passed directly to MPEG Decoder/Multi Media Processor 449. Encoder 441 is operative to perform predetermined coding techniques (for example, MPEG-2, MPEG-4, and others) to produce an encoded video signal for transmission to MPEG Decoder/Multi Media Processor 449, or for storage. MPEG Decoder/Multi-Media Processor 449 is operative to perform predetermined coding techniques to arrange video information into displayable formats, in accordance with well-known methods and techniques. Internal arrangements of MPEG Decoder/Multi-Media Processor 449 are well known, and may include analog-to-digital converters, one or more storage media and/or buffers, and general or special-purpose processors or application-specific integrated circuits, along with demultiplexers for demultiplexing and/or synchronizing at least two transport streams (for example, video and audio).

An electronic program guide (EPG) 455 is also provided in set top terminal 400. The EPG 455 is an interactive, on-screen display feature that displays information analogous to TV listings found in local newspapers or other print media. An EPG provides information about each program being broadcast within the time period covered by the EPG, which typically ranges from the next hour up to several days. The information contained in an EPG includes programming characteristics such as, for example, channel number, program title, start time, end time, elapsed time, time remaining, a brief description of the program's content and possibly the names of individuals associated with the program such as the actors, writers and director. The EPG, which is generally received along with the programming content, may be updated on a periodic basis so that the consumer can make appropriate selection for upcoming programs. For example, the electronic program guide 455 may display programs in a tabular format by channel and time so that the user can make selections of desired content. In some cases, instead of transmitting it along with the programming, the electronic program guide 455 may be downloaded via a telephone line, cable connection, satellite up-link, down-link, or radio broadcast antenna.

An on-screen display unit 450 is provided in set top terminal 400. The on-screen display unit 450 is used to display information such as control menus and the like as well as information received from the service provider or MSO that needs to be directly presented to the user regardless of the particular programming or channel that the user is currently viewing. In particular, on-screen display unit 450 displays the information provided by the EPG 455. Accordingly, on-screen display unit 450 can forward the information directly to the display unit 470, where it may appear as an overlay, pop up, or scrolling text ticker that is superimposed on the current programming being viewed. Alternatively, the information from the on-screen display unit 450 may even replace the current programming that appears on the display unit 470.

DVR subsystem 460 is provided for recording programs received from the content delivery system. DVR subsystem 460 can control the channel tuned by tuner 402 and record programming on a manual or timer control basis. Additionally, the DVR subsystem 460 can buffer incoming programs to enable a viewer to pause or replay a portion of a live program.

Set top terminal 400 further includes a computer-readable storage medium 406. Computer-readable storage medium 406 may be any local or remote device capable of recording or storing data, and in particular may be, or may include, a read only memory (“ROM”), flash memory, random access memory, a hard disk drive, all types of compact disks and digital videodisks, and/or magnetic tape. Various application programs may reside on storage medium 406. The applications residing on storage medium 406 may be computer programs that include software components implemented according to well-known software engineering practices for component-based software development and stored in computer-readable memories, such as storage medium 406. The applications, however, may be any signal processing methods and/or stored instructions, in one or more parts, that electronically control functions set forth herein. Storage medium 406 may also include other programs to provide additional functionality. For example, a network interface program 408 may be provided that represents aspects of the functional arrangement of various computer programs that pertain to the receipt and processing of content and other data over a broadband system.

The various components of set top terminal 400 discussed above may all operate under the overall control of a processor 465. Moreover, it is contemplated that the processor 465, tuner 402, video decoder 449, user interface 404, onscreen display unit 450 and the other components shown in FIG. 4 may each be implemented in hardware, software or a combination thereof. In addition, although the various components are shown as separate processors, it is contemplated that they may be combined and implemented as separate processes on one or more processors.

As previously mentioned, it would often be helpful if the SDV manager in an SDV system had as much advance information as possible concerning the amount of upcoming SDV bandwidth that each QAM modulator would be required to make available. In some cases this can be readily accomplished when an SDV program is scheduled to be recorded. In conventional systems, when a DVR program is scheduled to record a program in advance of the time the program will be delivered, either by manually programming the time and channel to be recorded, or by setting the recording through the EPG, the set top terminal (specifically e.g., SDV application module 304) does not inform the SDV manager until immediately before the scheduled recording time. At the scheduled time, the set top terminal simply requests the SDV program that is to be recorded. However, in the arrangement described herein, the set top terminal informs the SDV manager in advance of the scheduled recording time that a recording is scheduled. This information can be provided to the SDV manager along with other status information that the set top terminal regularly provides to the SDV manager, such as tuning information, for example. The scheduled recording information can be communicated to the SDV manager using a control channel such as the aforementioned in-band, out-of-band (OOB) or DOCSIS channels or an IP tunnel or an IP connection and associated protocols. The scheduled recording time, along with an identification of the program or channel to be recorded, can be provided to the SDV manager at the time the recording is programmed or otherwise established by the subscriber via a user interface associated with DVR application module 306, or at some predetermined time in advance of the scheduled time (e.g., 15 minutes, a half hour, hour or several or more hours in advance).

As shown in FIG. 2, the headend 110 may include an SDV recording scheduling database 250. The SDV manager 215 can store the scheduling information concerning upcoming recordings in the database 250. The SDV manager will access the scheduling information in database 250 when allocating and load balancing resources in the content delivery system to ensure that upcoming SDV programming can be efficiently delivered.

At the scheduled time, the set top terminal will request the SDV program that is to be recorded in the normal manner. That is, a second message is sent by the set top terminal (specifically, e.g., by the SDV application module 304) requesting delivery of the program. In some cases the initial message sent to the SDV manager 215 will also include the request to transmit the SDV program at the scheduled time. In this way a second message need not be sent at the scheduled time requesting that the program be delivered. In this case the SDV manager 215 will access the database 250 at the time an SDV program is to be delivered in order to identify the particular program that is being requested and the subscriber to whom the program is to be delivered. In some cases however, logistical difficulties may make it undesirable to send a single message that both reserves system resources such as bandwidth and requests delivery of the SDV program at the scheduled time and thus two separate messages may be preferred.

In some cases, the length of the advance notice that is received about an upcoming scheduled recording, along with other factors such as the system resources currently being used, will determine how system resources such as bandwidth are to be allocated at the time of the recording. For instance, if the notification is received 5 hours in advance system resources may be allocated one way, whereas if the notification is received only 10 minutes in advance resources may be allocated in a different way. A wide variety of additional factors may be taken into consideration when allocating system resources for an upcoming scheduled recording, including perhaps the length of the program to be recorded, the number of other programs scheduled to be recorded at that time that are equal in length, and the like. Of course, the manner in which system resources are to be allocated may depend on a myriad of other parameters, including, perhaps, the amount of advance notice that is received relative to the length of the program that is scheduled for recording. For instance, in some cases it may be desirable to receive advance notice at least equal to the duration of the program being recorded. That is, if a program a half hour in length is scheduled for recording, the set top terminal may notify the session manager at least about a half hour in advance. Likewise, if a program an hour in length is scheduled for recording, the set top terminal may notify the session manager at least about an hour in advance. In some cases this will allow the session manager sufficient time to perform load balancing among the various QAM modulators. Such load balancing and other allocation of system resources will generally be performed so that a maximum number of the SDV programs scheduled for recording can be delivered at their scheduled times. The SDV manager may allocate network resources such as bandwidth based not only on scheduled recordings, but also on other factors or information that may be provided to it by the set top terminal. For example, simply because a set top terminal is tuned to a particular SDV program that has been requested by the subscriber does not mean that the subscriber continues to watch the program for its entire duration. The set top terminal can sometimes infer whether or not a subscriber is actively viewing an SDV program. If the subscriber is not recording and not actively viewing the SDV program, the SDV channel can be switched off and reassigned. Such an inference can be made in a number of ways. For example, the set top terminal may be able to determine the status of the television or other display device on which the program is being viewed, such as by sensing signals being communicated over a DVI/HDMI cable that is sometimes used to connect the set top terminal to the display. If the display is turned off, then the subscriber is clearly not actively viewing the program.

An inference that a subscriber is not actively viewing an SDV program that is being provided may be made in other ways as well. For example, if as time goes by the set top terminal has not received any user input whatsoever, there arguably may be a diminishing probability that a viewer is actively watching the SDV program. Accordingly, monitoring user input activity may provide additional information that can be help to determine whether the subscriber is actively viewing the SDV program.

As noted above, if the set top terminal determines that a subscriber is not recording nor actively viewing an SDV program that is being received, the SDV manager may switch off the SDV channel on which program is being supplied. However, based on an upcoming recording the subscriber has scheduled in advance, the SDV manager may instead decide that the SDV channel should remain active in order to best manage system resources. For instance, if a subscriber is receiving an SDV channel at 8 pm and at 8:55 pm the SDV manager concludes that the subscriber is neither actively watching nor recording the program being supplied on that channel, the SDV manager may switch off the SDV channel. Instead, however, if the SDV manager is aware that the subscriber, or another subscriber in the same service group, will be recording a program on the same SDV channel at 9 pm, the SDV manager may allow the SDV channel to remain active since it will need to be supplied to a subscriber in the same service group once again in 5 minutes. Stated differently, the SDV manager may use the information concerning upcoming scheduled recordings to override or modify its determination that a particular SDV channel should be shut down because it is not being actively viewed.

In the various examples presented above the SDV manager or other suitable entity in the content delivery system receives notification of upcoming scheduled recordings and possibly current set top terminal usage activity by the subscriber, and, based on this information, determines how SDV network resources should be allocated. In some cases, however, some or all of this information may be locally processed by the set top terminal itself before being communicated to the SDV manager. For instance, in one example, the set top terminal will use the information concerning upcoming scheduled recordings, current set top terminal usage activity, and any other pertinent factors to inform the SDV manager whether it has a continuing need for an SDV channel. In this way the raw information does not need to be sent to the SDV manager for processing. Rather, the processing is performed locally in the set top terminal. One disadvantage of this approach is that the SDV manager cannot fully assess and balance the various needs of the individual set top terminals currently using SDV system resources with the total available system resources. In some cases, however, the savings in processing required on the part of the SDV manager may more than justify the reduction in the depth of analysis that can be performed by the SDV manager.

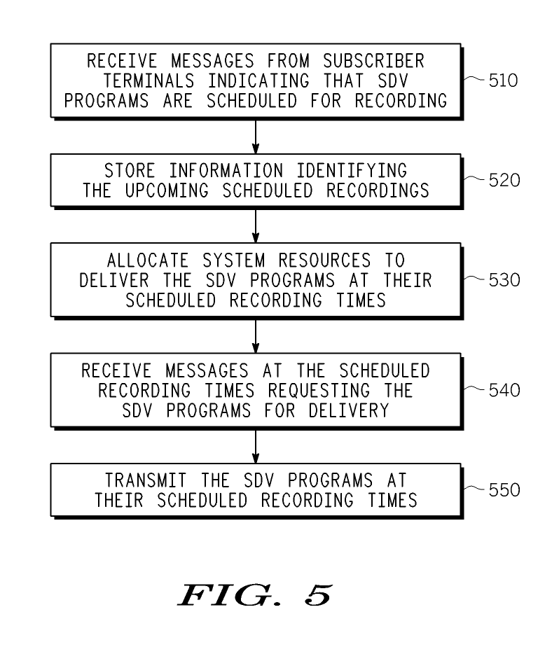

FIG. 5 is flowchart showing one example of a method by which the SDV manager or other suitable entity in the content delivery system delivers SDV programs that are to be recorded by subscriber terminals (e.g., set top terminals). The method begins at step 510 when the SDV manager receives from various subscriber terminals a message indicating that an upcoming SDV program is scheduled for recording. In step 520, the SDV manager stores, for each of the subscriber terminals, upcoming scheduled recordings information. The upcoming scheduled recordings information includes an identification of the SDV program to be recorded and a scheduled time at which the SDV program is to be delivered. The SDV manager, at step 530 then allocates resources (e.g., QAM modulators, bandwidth) in the content delivery system for delivering the SDV programs scheduled for recording based at least on the upcoming scheduled recordings information that is stored. When their scheduled recording times arrive, the SDV manager at step 540 receives another message from each of the subscriber terminals. It should be noted that in some implementations step 540 may be optional. Each messages requests delivery of the SDV program that has been scheduled for recording by the individual subscriber terminals. In response to the requests, the SDV manager transmits to the subscriber terminals system their respective SDV programs at step 550.The processes described above, including but not limited to those presented in connection with the headend and set top terminal may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. At least one computer-readable medium encoded with instructions which, when executed by a processor, performs a method including:
receiving from each of a plurality of subscriber terminals a message indicating that an upcoming SDV program deliverable over a content delivery system is scheduled for recording by each of the subscriber terminals;
storing, for each of the subscriber terminals, upcoming scheduled recordings information including an identification of the SDV program to be recorded and a scheduled time at which the SDV program is to be delivered; and
allocating resources in the content delivery system for delivering the SDV programs scheduled for recording based at least on the upcoming scheduled recordings information that is stored.

2. The computer-readable medium of claim 1 further comprising:
subsequent to receiving the messages, receiving from each of the subscriber terminals a request to deliver the SDV programs to the respective subscriber terminals; and
in response to the requests, transmitting to the subscriber terminals over the content delivery system the respective SDV programs.

3. The computer-readable medium of claim 1 wherein the messages are received when each recording is established by the users.

4. The computer-readable medium of claim 1 wherein the messages are received in advance of the scheduled times by a time period at least equal to the duration of the respective SDV programs being recorded.

5. The computer-readable medium of claim 1 further comprising allocating resources in the content delivery system so that a maximum number of the SDV programs scheduled for recording can be delivered at the scheduled time.

6. The computer-readable medium of claim 5 wherein allocating resources includes performing load balancing to distribute delivery of the SDV program among a plurality of edge devices.

7. The computer-readable medium of claim 5 wherein the resources to be allocated comprise bandwidth between an edge device and the subscriber terminal.

8. The computer-readable medium of claim 1 further comprising:
receiving and storing, for at least some of the subscriber terminals, additional information concerning current subscriber viewing activity; and
allocating resources in the content delivery system based at least in part on the additional information and the upcoming scheduled recording information that is stored.

9. The computer-readable medium of claim 1 wherein, for at least one of the subscriber terminals, the message includes an indication of whether delivery of an SDV channel currently being provided to the one subscriber terminal should be terminated or maintained.

10. The computer-readable medium of claim 9 wherein the indication includes an indication of current viewing activity with respect to the SDV channel currently being provided to the one subscriber terminal.

11. The computer-readable medium of claim 1 wherein the messages each include a request to deliver the SDV programs at their respective scheduled times.

12. A set top terminal comprising:
a tuner for receiving SDV programs over a content delivery system;
an SDV module for coordinating SDV sessions in cooperation with an SDV manager associated with the content delivery system;
a DVR module for coordinating storage and playback of SDV programs received over the content delivery system, wherein the SDV module is configured to transmit a message over the content delivery system substantially in advance of a time at which an upcoming SDV program is scheduled to be recorded by the DVR module, wherein the message specifies when the upcoming SDV program has been scheduled for recording; and
a processor operationally associated with the tuner, the SDV module and the DVR module.

13. The set top terminal of claim 12 wherein the message further includes additional information concerning current subscriber viewing activity.

14. The set top terminal of claim 12 wherein the SDV module is further configured to determine if an SDV channel that is currently being received should continue to be received and wherein the message includes a result arising from the determination.

15. The set top terminal of claim 12 wherein the SDV module is configured to transmit the messages when each recording is established by users.

16. The set top terminal of claim 12 wherein the SDV module is further configured to transmit a second message over the content delivery system when the SDV program is scheduled to be recorded, wherein the second message requests delivery of the SDV program.

17. The set top terminal of claim 12 further comprising an EPG module for formatting EPG data received over the content delivery system, wherein the DVR module is configured to schedule the upcoming SDV program for recording through the EPG module.

18. At least one computer-readable medium encoded with instructions which, when executed by a processor, performs a method including:
receiving from a subscriber terminal a first message indicating that an upcoming SDV program deliverable over a content delivery system is scheduled for recording by each of the subscriber terminals;
subsequent to receipt of the first message, receiving from the subscriber terminal a second message requesting delivery of the SDV program; and
transmitting the SDV program to the subscriber terminal over the content delivery system.

19. The computer-readable medium of claim 18 wherein the first message is received in advance of the scheduled time by a time period at least equal to the duration of the SDV program being recorded.

20. The computer-readable medium of claim 18 wherein the first message includes an indication of current viewing activity with respect to the subscriber terminal.
